(19) United States
(12) Patent Application Publication
(10) Pub. No.: US 2009/0045355 A1
(43) Pub. Date: Feb. 19, 2009

(54) METHOD FOR GENERATING ENTANGLED ELECTRON, INFRARED-RAY, VISIBLE-RAY, ULTRAVIOLET-RAY, X-RAY AND GAMMA-RAY BEAMS

(76) Inventor: Robert Desbrandes, Givarlais (FR)

Correspondence Address: E-QUANTIC COMMUNICATIONS, 1, ALLEE DES CHERINIERS, GIVARLAIS, FR-03190, FR

(21) Appl. No.: 12/162,352

(22) PCT Filed: Jan. 29, 2007
(86) PCT No.: PCT/EP07/50840

§ 371 Date: Jul. 26, 2008

(30) Foreign Application Priority Data
Jan. 31, 2006 (FR) 0600967

(51) Int. Cl. H01J 43/04

(52) U.S. Cl. 250/503.1

(57) ABSTRACT

The method for generating entangled beams of electrons, gamma-ray, X-ray, ultraviolet, visible or infrared photons comprises the following elements: an entangled photon beam generator using a BBO crystal, two branches each containing a photon-to-electron converter (photocathode), an electron amplifier (photomultiplier), an electron accelerator and a target that converts the kinetic energy of the electrons into entangled gamma-ray, X-ray, ultraviolet, visible or infrared photons. The beams obtained in each branch contain groups of gamma-ray, X-ray, ultraviolet, visible or infrared photons that are mutually entangled and entangled with the corresponding groups of the other branch. The entangled electrons may also be used as such before interaction with the target. Variants of the method are presented. One application of the method is the preparation of entangled thermoluminescent products by irradiation by means of entangled gamma-ray beams. The thermoluminescent products then contain entangled trapped electrons and may be used for implementing quantum communications over any distance and through any medium.

### TECHNICAL FIELD

The present invention relates to the processes of production of entangled electron beams, of entangled gamma rays and X rays and, of entangled ultraviolet rays, visible, infrared.

The phenomenon of entanglement was mathematically demonstrated since 1925 by the theorists of the time: L. V. of Broglie, E. Schrödinger, C. Heisenberg, P. A. M. Dirac, J. A. Wheeler, J. Neumann, and many others. The quantum theory shows that two particles emitted simultaneously (or almost simultaneously) by the same object have a common wave function, and the modifications of the quantum state of the one particle is reflected on the quantum state of the other particle immediately and wherever it is in the universe.

For example, there exist crystals which can transform a photon of light into two photons, these photons are entangled. For the photons, the entanglement appears by the fact that their polarization is not defined. When one determines the polarization of the one photon, polarization of the other photon is immediately determined. This was proven in Geneva around 1995 when the photons had been transported 10 kilometers away from each other with an optical fiber.

Certain theorists were not in agreement with the theory of Quantum Mechanics in the years 1930 to 1940. In particular, A. Einstein in 1935, published a short article [1] in which he indicated that the theory of Quantum Mechanics was incomplete. In 1965 [2], J. S. Bell, at the CERN, proved that Quantum Mechanics was “not local”, i.e. that the instantaneous interactions were possible.

Around 1980 [3], A. Aspect, in the Optical Center of the University of Paris, confirmed by the experimentation that the theory of J. S. Bell was correct. Since 1990, the experiments follow one another, those of Geneva, others in Austria and in the United States of America, to confirm the entanglement of particles. They are primarily experiments with photons of light, but also with electrons [4]. The possible applications are primarily, for the moment, in cryptography in the coded transmissions and in the field of computers. Very recent research in the domain shows that this entanglement can worsen by a phenomenon of décohérence [5], but that it can also be transmitted from quantum particles to quantum particles [6, 7].

### REFERENCES

[1] Einstein A., Podolski B., Rosen N., <<Can Quantum Mechanical Description of Physical Reality Be Considered Complete>>, Physical Review, 47, (1935), pp. 777-780
[2] Bell J. S., <<Speakable and Unspeakable in Quantum Mechanics>>, New York, Cambridge University Press, 1993.
[3] Aspect A., <<Trois tests expérimentaux des inégalités de Bell par mesure de corrélation de polarisation de photons>>, Thése de Doctorat d'Etat, Université de Paris Orsay, 1er Février 1983.
[4] C. H. Bennett, G. Brassard, S. Popescu, B. Schumacher, J. Smolin, and W. Wootters, “Purification of Noisy Entanglement and Faithful Teleportation via Noisy Channels,” Phys. Rev. Lett. 76, 722-726 (1996)
[5] R. F. O'Connell, “Decoherence in Nanostructures and Quantum Systems,” Physica E, 19, 77 (2003).
[6] Altewischer E., van Exter M. P., and Woerdman J. P., <<Plasmon-assisted transmission of entangled photons>>, Nature, 418, 304-306, (18 Jul. 2002).
[7] Chanelière, T. et al., <<Storage and retrieval of single photons transmitted between remote quantum memories>>, Nature, 438, 833-836, (8 Dec. 2005).
[8] Desbrandes Robert et Van Gent Daniel Lee, Demande internationale OMPI No WO 2005/109985, Procédé et appareillage pour modifier la probabilité de désexcitation des nucléides isomères, date de priorité 13 avril 2004, publiée le 24 novembre 2005.
[9] Desbrandes Robert et Van Gent Daniel Lee, Demande internationale OMPI No WO 2005/112041, Procédé et appareillage pour communiquer à distance en utilisant des nucléides isomères, date de priorité 13 avril 2004, publiée le 24 novembre 2005.

[10] Desbrandes Robert et Van Gent Daniel Lee, Demande internationale OMPI No WO 2005/117306, Procédé et appareillage pour communiquer a distance en utilisant la photoluminescence ou la thermoluminescence, dates de priorité 26 mai 2004 et 12 avril 2004, publiée le 8 décembre 2005.
[11] Kurtsiefer C., Oberparleiter M., and Weinfurter H., <<Generation of correlated photon pairs in type II parametric down conversion—revisited>>, Feb. 7, 2001, submitted J. Mod. Opt.
[12] Smith A., V., <<How to select non linear crystal and model their performance using SNLO software>>, SLNO software from Sandia National Laboratory. http://www.sandia.gov/imrl/XWEB1128/snloftp.htm
[13] Ralph W., Engstrom, Photomultipliers Handbook, RCA, 1980, et Flyckt, S. O. and Marmonier, C., Photomultiplier Tubes: Principles and Applications, Photonis, Brive, France, (2003).
[14] Wangler Thomas P., RF Linear Accelerators (Wiley Series in Beam Physics and Accelerator Technology), Wiley, May 1998.
[15] Sameer S. A. Natto, Belal Moftah, and Noor M. H. Ghassa, <<Heterogeneity Correactions For High Energy Photon Beams (Measurements and Calculations)>>, Journal of Australian Physical & Engineering Sciences in Medicine, 26, 3, pp 78-82, 2003.
[16] Oliver W. D., et al, <<Hanbury Brown and Twiss—Type Experiment with Electrons>>, Science, 9 Apr. 1999, Vol. 284, no. 5412, pp. 299-301.
[17] Hasegawa S. et al, <<Electron holography apparatus>>, U.S. Pat. No. 4,935,625, issued Jun. 19, 1990.

### Former Technique:

There exist apparatuses, which produce a beam of partially entangled gamma rays or X rays [8, 9, 10]. There exist apparatuses based on non-linear crystals, which emit separate beams of entangled photons [11, 12].

The patent in reference [8] describes a method and an apparatus to modify the lifespan of metastable nuclei. The patent in reference [9] describes a method and an apparatus to use the entanglement of metastable nuclei for telecommunications. The patent in reference [10] describes a method and an apparatus to use the entanglement of the traps in photoluminescent or thermoluminescent material for telecommunications.

These apparatuses use an accelerated electron beam: each electron causes by Bremsstrahlung effect the emission of a spectrum of photons comprising for example photons of types gamma, X, ultraviolet, visible, or infrared, or a combination of some of these types of photons. An intrinsic limitation of the process is that the sum of energies Eᵢ of k photons entangled to each other, in whole or in part, produced by Bremsstrahlung effect at the time of the incidence of an electron, is lower or equal to energy E of the aforementioned electron.

In particular the processes [8, 9, 10] make uses of photons of energies of excitation Eₑₓ, which must be definitely higher than the value of the energy of the isomeric transition Eₘ to obtain a transfer of entanglement, for example by exciting the nuclei of the isomer nuclides to a given metastable state. Consequently the aforementioned processes do not make it possible to generate more than E/Eₑₓ photons gamma entangled to each other. As Eₑₓ is not always known, an upper limit of the number of photons entangled to each other is given by E/Eₘ. This limit is not reached in practice by the aforementioned processes taking into account the difference between Eₘ and Eₑₓ.

For example to excite Indium 115: Eₘ=336 keV, Eₑₓ=1088 keV. A linear accelerator of type CLINAC produces, for example, accelerated electrons of energy E=6 MeV. The number of gamma photons entangled to each other will never exceed E/Eₑₓ=5, nor the upper bound E/Eₘ=17. In practice, FIG. 4 shows that the energy of the maximum number of emitted gamma is 1.5 MeV, which leads to a maximum of 4 gamma photons entangled to each other.

### Disclosed Invention:

The invention concerns a process to obtain the product made up, either of an accelerated electron beam, or of a photons beam made of photons of types gamma, X, ultraviolet, visible, or Infrared, entangled in whole or in part, or, of several beams, entangled in whole or in part, of accelerated electrons, or of photons of types gamma, X, ultraviolet, visible, or infrared, themselves entangled to each other, in whole or in part. The invention consists in the application of the transfer of the entanglement of some particles to other particles, or the generation of several entangled particles starting from one particle, or of a combination of these two techniques to transfer the entanglement from several entangled particles, each one with a group of particles themselves entangled, these groups being entangled to each other.

For example the entanglement from ultraviolet, visible, or infrared, photons is transferred to entangled electrons by means of photocathodes, the entanglement from electrons is transferred to other electrons by means of dynodes, the entanglement from electrons is transferred to photons by Bremsstrahlung effect, or groups of entangled electrons are generated by starting with electrons hitting dynodes.

A description is presented below of the various components known individually and associated in this invention to implement entangled beams of entangled electrons, or of gamma, X, ultraviolet, visible, or Infrared, entangled photons.

The modules of the apparatus, described in the invention below, exist like separated units, for applications, such as the production of entangled beams of light used in cryptography, the detection of very weak luminosities, the production of X-ray, or gamma, for medical applications, and the acceleration of particles in the apparatuses used for the collision of particles:

### 1—Generator of Entangled Beams of Photons of Ultraviolet, Visible, or Infrared, Light:

Beams of entangled luminous photons are produced with non-linear crystals, for example crystals of borate oxide Barium (BBO) or Lithium triborate (LBO). This is obtained by illumination of these crystals by a polarized laser beam [11, 12].

FIG. 1 shows the diagram of a typical system to obtain two beams of entangled luminous photons. A laser beam (1) is directed to the non-linear crystal (3) through the polarizer (2). The principal axis (4) of the crystal is directed according to the angle (5). Two entangled beams (6) and (7) are emitted in the plan of polarization and in two different directions. These beams can have the same wavelength, or different wavelengths. They are generally very weak, about one photon entangled with one photon of the other beam for 10⁺²⁰ photons emitted by the laser. The beam (8) at the exit of the crystal is not used.

### 2—Generator of Electrons by Photoemission [13]

Electrons are emitted by the photocathodes when they are irradiated, or illuminated, by infrared, visible, or ultraviolet, photons. These photocathodes are, for example, made of layers of Bi-alkali materials made up of antimony alloys and other metals such as Rubidium, Potassium, and Cesium. Other metals can be added to extend the spectral response.

The output of these photocathodes varies from 1% to 40% according to the type of photocathode and the wavelength of the incident photons. Some photocathodes function with an average efficiency of 10 to 30% for wavelengths going from 175 to 800 nm. The material used to support the sensitive layers is, for example, made of borosilicate glass, or quartz for the ultraviolet photons (down to 160 nm), or of Magnesium fluoride for the ultraviolet photons (down to 110 nm), or of sapphire (Al2O3) for ultraviolet photons and harsh environments.

FIG. 2 schematically represents the photocathode (9) which, under the action of the photons (10), emits the photoelectrons (11).

### 3—Amplifier of the Number of Electrons [13]:

On FIG. 2, the photoelectrons (11) emitted by the photocathode, as in the photomultipliers, are directed towards a dynode (12) whose potential is higher, for example of 100V. An electrode, or a magnetic lens, (13) allows the focusing of the electron beam on the first dynode. The impact of each photoelectron causes the emission of several electrons (14). This process is repeated up to 18 times for an amplification being able to reach 10 million. In the photomultipliers, the resulting electron beam (15) is generally directed on an anode (16) whose current is measured.

### 4—Accelerator of Electrons [14]:

The apparatuses which amplify the kinetic energy of the electrons, i.e. their speed, are accelerators. There are several kinds: linear accelerators, cyclotrons, rodotrons, etc All receive electrons generally of weak kinetic energy, coming, for example, from a thermo-emission generator, or from a photoemission generator (17). The linear accelerators are the most current. They are constituted in a series of electrodes as FIG. 3 shows schematically. The principle of the “resonant” acceleration is used. The electrons are admitted in (18), coming for example from a photocathode (19), and after a magnetic focusing (20). The electrodes (21), which are alternatively positive and negative using the generator (22), gradually accelerate the electrons which, thus, pass from a kinetic energy of, for example 100 eV, to an energy in the range of MeV, or even of GeV in the large accelerators. They leave in (23).

### 5—Target [15]:

To obtain by Bremsstrahlung effect a spectrum of rays of great energy, for example containing a great quantity of gamma, or of less energy, for example X rays, ultraviolet rays, visible, or infrared, the electron beam is projected, after focusing, for example by means of a magnetic lens, towards a tungsten target for example. The target is represented in (24) on FIG. 3. For example gamma rays (25) from the target have an energy spectrum which is represented on FIG. 4. In this Figure, the accelerator is a CLINAC (Accelerator Linear Compact: “Compact Linear Accelerator”) apparatus. The electrons of the beam have an energy of 6 MeV. The spectrum of emitted gamma extends from 0 to 6 MeV as shown in the FIG. 4. It passes by a maximum around 1.5 MeV [15]. According to some publications [8,9], the X-rays and gamma emitted by the target of the CLINAC are entangled by two, three, or four, owing to the fact that only one electron emits by Bremsstrahlung, and practically simultaneously, the X-rays or gamma rays.

The generators of X-rays are made of lighter metal targets such as Copper. The X-rays come from Bremsstrahlung but mainly from the jump of an electron L in the orbit K to replace the electron K which was ejected. In this case, the X-rays are a mix of X-rays coming from interaction K and Bremsstrahlung. Only the rays of Bremsstrahlung are entangled.

In the cathode ray tubes, the target is a fluorescent screen. It is bombarded by electrons with an energy of about 25 keV. The traps of the fluorescent product are excited and re-emit practically instantaneously luminous rays of various wavelengths according to the type of fluorescent material. The excitation of the traps requiring only some eV, an electron excites several traps; this process results is an entanglement of the photons emitted by the same electron.

### 6—Divider of Electron Beam:

The technique of division of the electron beams is used in electron microscopy [16]. The dividers of electron beams are also used for applications of electronic holography [17].

### Manners of Associating the Preceding Modules to Implement the Invention:

In the best manner to implement the invention, one uses mainly the elements described previously in a device represented in FIG. 5 in its principle. Other mode of implementation will be represented in the continuation.

On this Figure, a laser (26) emits infrared, visible, or ultraviolet, rays polarized through a polarizer (27). These rays meet a non-linear crystal (28). This non-linear crystal has the property to emit in the plan of polarization, in addition to the beam which crosses the crystal, two entangled beams of photons (29) and (30) according to an angle (31) in relation to the principal beam. These beams, much weaker than the principal beam, are optionally reflected by the mirrors (33) and (34), according to the construction of the apparatus. The aforementioned beams are generally called “signal” and “idler”. The principal beam is absorbed by an absorber (“phantom”) (32). This type of production of entangled beams of luminous photons is well-known of the man of the art. Some crystals, under certain conditions produce two beams for which the wavelength of the photons is twice the wavelength of the incidental laser beam. One can also obtain beams for which the wavelength of the photons is different. In this case, however, the sum of the energy of the entangled photons is equal to that of the photons incident from the laser.

The beams are sent on two separate channels which start with the photocathodes (35) and (36). These photocathodes emit entangled electrons of weak energy. Indeed, the entanglement is a robust phenomenon and the transmission of the entanglement from a quantum particle to another is possible [6, 7, 8, 9]. The theory of the photoemission is well-known. The law of Einstein indicates that the Eₑ energy, in Joule, of the electron emitted by a photon of frequency nu, in Hertz, incident on a surface whose work of extraction of the electron is phi, in Joule, is of the form:

Eₑ=h·nu−phi

h being the Planck's constant (h=6.63 10⁻³⁴ J·s).

In more practical units:

Eₑ=1240/lambda−phi

In this equation, Eₑ is in eV, lambda, the wavelength, in nm, and phi is in eV

For example, if lambda=400 nm (violet light), if phi=2.14 eV (Cesium),

Eₑ=0.96 eV=1.53 10⁻¹⁹ J.

Metals generally used, such as Tellurium, Gallium, Antimony, Arsenic, etc, have an extraction work from 2 to 7 eV.

The energy of the electron is a kinetic energy. Its speed, in the case of the Cesium, is thus:

V=(2Eₑ/m)^{0.5}=5.8 10⁺⁵ m/s

with m, mass of the electron=9.109 10⁻³¹ kg.

According to the law of Einstein, a photon causes the ejection of one electron. Consequently, the entanglement of the photon with another photon of the other branch of the system is transferred to the electron.

The output of the best photocathodes is, at present, approximately 25%. On one of the beams, one entangled photon out of four transmits its entanglement to an electron. It will be the same on the other beam. It results from it that, in this case, one photon out of 16 of each beam transmits its entanglement to an electron which is entangled with another electron in the other branch of the system. An increase in the output of the photocathodes thus increases quickly the output in term of entangled electrons. It is important that transit times of the photons starting from the nonlinear crystal are equal in the two branches of the system to obtain an optimal transmission of the entanglement. In the present invention, the electrons are multiplied by a method similar to that used in the photomultipliers. The electrons with the speed V are focused and directed, in each branch of the device, towards the multipliers of electrons (37) and (38). Those comprise a first dynode which creates an electric field EE. This field is due to an electric voltage applied to the dynode, for example of approximately 100 V, at a distance, D, for example of 1 cm (0.01 m). The field is thus of 10000 V/m. The ejected electrons, for example of a Cesium photocathode, by some photons of 400 nm, is accelerated and acquires an additional energy according to the equation:

Eₛ=EE×D=100 eV

The total energy when the electrons meet the dynode, E_{d}, is thus of:

E_{d}=Eₑ+Eₛ=100.96 eV=1.62 10⁻¹⁷ J.

The corresponding speed, Vd, is:

Vd=(2Ed/m)^{0.5}=5.9 10⁺⁷ m/s

With m the electron mass of 9.11 10⁻³¹ kg.

The mean velocity of the electron during the trip is thus of:

Vₘ=(V+V_{d})/2=2.95 10⁺⁷ m/s

The time necessary to traverse the distance from the photocathode towards the first dynode is thus of:

d/Vₘ=3.38 10⁻¹⁰ s=338 ps

This time is much lower than the time necessary for an appreciable décohérence of the state of entanglement of the electrons. One can thus consider the electrons emitted by the photocathode as always entangled when they meet the first dynode. The electrons generally meet the surface of the dynode with an angle of incidence about 45°. Consequently, the energy of the electrons is primarily dissipated by the emission of several electrons and not by Bremsstrahlung.

The dynodes generally have a surface made up of beryllium-Copper or Antimony-Cesium. The work of extraction for these metals goes from 2 to 5 eV.

In the case of the incident electrons, several secondary electrons are ejected.

By supposing that their energy is similar to that of the electrons emitted by the photocathode, that is to say 1 eV, 3 to 5 eV are necessary to eject an electron. As 100 eV are available, theoretically 20 to 30 secondary electrons could be ejected by the action of only one electron. The efficiency of the dynodes is such that generally 5 to 10 electrons per incident electron are ejected. The ejected electrons coming from an entangled electron are then electrons entangled to each other and with the corresponding electrons of the other branch of the system.

The same phenomenon reproduces from one dynode to another since generally the same electric field is applied between dynodes and finally towards the final anode, which in our case has a particular configuration. In the case where, for example, 5 dynodes are used. With a gain of 5 electrons per dynode, one obtains a total gain of 3125 and with a gain of 10 electrons by dynodes, one obtains a total gain of 100000. One thus has at the exit of last dynode 3125 or 100000 entangled electrons between each other and entangled with the 3125 or 100000 corresponding electrons of the other branch of the system which are themselves entangled to each other. The efficiency of the transfer of entanglement can be partial, since a proportion of the produced electrons are entangled between them, or with those of the other branch of the system, according to the optimization of the process.

In the present invention, the non-collecting anode, which terminates the part in which the number of electrons increases, is provided, for example, with an opening in its center, and makes it possible for the electrons to continue their running towards the next module, which is the accelerator, increasing the energy, therefore the speed of the electrons. It is important that the transit times of the electrons between the various components in the multiplier of electrons have the same value in the two branches of the device to obtain an optimal transfer of the entanglement.

An accelerator is placed on each branch of the device. They are represented on FIG. 5 by the reference (39) and (40). The simplest module is constituted only of one anode electrode with a potential of million volts to accelerate the electrons. For example, to reach an energy of 6 MeV, the electrode is set at 6 million volts. In this case the flow of electrons is continuous. Some accelerator of electrons modules using lower potentials and giving the same result are well-known to the men of the art, the compact linear accelerator (“Compact Linear Accelerator” CLINAC) [15] is usually used for medical, or nuclear applications. A simplified diagram of the linear accelerator of the Wideröe type is given on FIG. 3. A beam of negative particles (18), focused in (20), such as electrons, is accelerated in the intervals with arrows towards the right. When the cycle of the generator (22) changes, the polarities change and the acceleration produces itself in the other intervals. During the change of polarity the electrons progress inside the electrodes (21). The potential difference between the various electrodes is the same. As the speed of the electrons increases, the length of the electrodes increases as the electrons progress in the apparatus. If the potential difference is for example of 100000 V, and the interval between electrode of 10 cm (0.10 m), the electric field will be of 1000000 V/m and the energy acquired by the electrons is 100 keV per interval. Although the accelerators are relatively long, about one meter, the very high speed of the electrons, due to the fact that it is relativistic and close the speed of the light, leads to transit times in the accelerator of about 330 ns (0.33 10⁻⁶ s). This time is also lower than the time necessary for an appreciable decoherence of the state of entanglement of the electrons. On the FIG. 5, the beams of electrons entangled between each other and with the electrons of the corresponding beam on the other branch of the system hit the targets (41) and (42). In this system, the electrons are propagated in very close groups since the frequency of change of the polarity is very high, about 200 Megahertz.

In the case of the X-rays, the energy necessary for the electrons is about 100 to 200 keV; Consequently, only a few stages in the accelerator are necessary, for example, two stages.

In the case of the luminous rays, generally one stage is sufficient to raise the energy of the electrons, for example, to 25 keV.

It is important that the travel times of the electrons in the accelerator of electrons have the same duration in the two branches of the device to obtain an optimal conservation of the entanglement and an optimal transfer of the entanglement during the bombardments of targets or samples by electrons.

The targets represented by the reference marks (41) and (42) are optional. The partially entangled beams of partially entangled electrons between each other can be used as such, or be directed towards Tungsten targets, for example, represented in each branch of the device by the references (41) and (42). The electrons of the beams interact then, by Bremsstrahlung effect, with the aforementioned targets. If, for example, an electron of the beams has an energy of 6 MeV, it generates several gamma of which the energy is distributed statistically on the spectrum of the curve of FIG. 4. The aforementioned gamma are emitted primarily forward at this energy and are represented by the references (42) and (43). Moreover, since the same electron emit several gamma rays and X-rays, these gamma and X are also entangled, what further increases the number of gamma partially entangled in the beams produced within the framework of the invention. One thus obtains two beams made up of a spectrum of gamma rays and of X-rays and consisting in groups of X-rays and gamma partially entangled between each other and entangled with the corresponding group on the other branch of the apparatus. For certain applications, some collimators, (45) and (46), are necessary to irradiate surfaces of a given size.

In this invention, the word “collimator” refers to a window placed on the beam of diverging X rays or gamma rays emitted by a source quasi punctual, to irradiate an area of definite dimensions. Just the same, the word “collimation” refers to the delimitation of an area to be irradiated. In the accelerators of the CLINAC type, the words “collimator” and “collimation” are used with the meaning of “window” and “delimitation” respectively.

Certain electrons, in particular for the targets of lighter metals such as Copper, interact with the electrons of the K orbit. In this case, the electron, which replaces that which was ejected by producing an X-ray, is not entangled and the emitted X-ray is not entangled. One thus prefers targets for which the interaction with the electrons of the K orbit is minimal to obtain a high efficiency. The targets for which the interaction with K electrons is large are however not excluded since a portion of the spectra is useful. This problem is especially important for the incident entangled electrons with an energy lower than 200 keV.

To obtain entangled rays in the field of the ultraviolet, visible, or infrared, photons, the target consists of fluorescent molecules. The impact of the entangled electrons of weaker energy, for example of 25 keV, causes the emission of photons to which the entanglement has been transferred. One thus obtains again two beams made up of a spectrum of ultraviolet, visible, or infrared rays and consisting of groups of ultraviolet, visible, or infrared rays partially entangled between each other, and entangled with the corresponding group on the other branch of the apparatus.

If one does not use targets one obtains groups of entangled electrons between each other and entangled with the group corresponding on the other branch of the apparatus. A version of the apparatus comprises one divider or several dividers, of electron beams between the multipliers of electrons (37) and (38) and the accelerators of electrons (39) and (40). One obtains then more than two electron beams. For example, in the case of a division of each branch, one obtains, if one does not use a target, four beams of electrons partially entangled, having a high energy, and, if a target is used, groups of gamma, X, ultraviolet, visible, or infrared rays partially entangled between each other.

It is also possible to use only one branch, with or without division, of the apparatus describes above with incident photons not entangled hitting the photocathode. In this case, when not using targets, one obtains one beam, or several beams, containing groups of electrons partially entangled between each other, and, when using one target, or several targets, one obtains groups of gamma, X, ultraviolet, visible, or infrared rays partially entangled between each other. The photocathode can also be replaced by a hot cathode, for example a cathode with oxide, which emits electrons by thermal agitation.

It is clear that by successive divisions the number of entangled beams is not limited.

The various steps used for the implementation of the process, object of this invention, and the characterization of the corresponding products are listed below according to the realization of the invention.

1—In the process to generate, either one beam of accelerated and entangled electrons, in whole or part, or several beams entangled, in whole or in part, of accelerated electrons themselves entangled between each other, in whole or in part, called in the continuation “process of reference”, one uses amongst other things:
the generation of electrons,
the multiplication of the number of electrons,
the acceleration of the electrons,

This process is characterized in that one carries out the following principal steps, called by convention “primary” steps:
a “primary” step of production of one entangled electron beam, in which one produces a beam of entangled free electrons, called beam of “multiplication”, in the following sub-steps, named by convention “secondary steps”:
   in a “secondary” step of generation of electrons in which one generates free electrons, for example, either by means of a hot cathode, or by means of a photocathode irradiated, or enlightened, by a beam respectively made up of ultraviolet, visible, or Infrared photons, or a combination of these types of photons, this photocathode transmitting the possible entanglement of the photons to the electrons generated in this case, the cathode, or the photocathode, being called by convention the “electrode” of the step,
   in another “secondary” step of multiplication of the entanglement, one causes entangled electrons, using the following sub-steps, called by convention “tertiary” steps:
      a “tertiary” step of introduction of the electrons into the first stage of the multiplier of entangled electrons, in which one directs, for example by means of a magnetic lens or of a focusing electrode, free electrons of the preceding step towards a dynode whose potential is higher than the “electrode” of the preceding step, for example of 100V. The impact of at least one electron on this dynode causing the emission of several electrons emitted simultaneously, or in a fast cascade, therefore to be entangled in whole or part between each other. When the primary electrons are themselves entangled with other electrons, a partial or total transfer of the entanglement of the primary electrons to the electrons occurs at the time of the impact to the dynode.
      In a “tertiary” optional step of multiplication of the entanglement in the second stage of the multiplier of entangled electrons, one directs the electrons produced in the preceding step towards a new dynode whose potential is higher than the preceding dynode, for example by 100 V. The impact of at least one electron causes the emission of several electrons emitted simultaneously, or in a fast cascade, therefore entangled in whole or part between each other, and when the primary electrons are themselves entangled with other electrons, with a partial or total transfer of the entanglement of the primary electrons to the electrons emitted by this new dynode at the time of the impact.
      In a “tertiary” optional step of additional multiplication of the entanglement in one intermediate stage, or several intermediate stages, of the multiplier of the entangled electrons, one repeats the preceding step from 1 to 99 times to obtain a great number of entangled electrons,
      In a “tertiary” step of exit of the electrons in the last stage of the multiplier of entangled electrons, one directs entangled electrons produced in the preceding step towards a non-collecting anode, whose potential is higher than the last dynode used, for example by 100 V. The aforementioned anode comprises, for example, either an opening in its center, or an ad hoc grid, this anode does not collect the electrons, and authorizes the passage of whole or part of the entangled free electrons, to form the beam of “multiplication”.
      In a “tertiary” optional step of focusing, one focuses, for example by means of a focusing magnetic lens, or of a focusing electrode, the beam of “multiplication”.
   In a “primary” optional step of division of the beam of “multiplication”, one produces two or several beams made up of entangled free electrons, possibly multiplied again, called “entangled” and “divided” beams, by the following sub-steps, named by convention “secondary steps”:
   In a “secondary” step of division of the beam of “multiplication”, one divides the preceding beam of “multiplication” into two or several beams made up of entangled electrons, for example by means of one or several magnetic lenses or focusing electrodes, the aforementioned beams being called the “divided” beam
   “secondary” optional step (of this “primary” step) of “multiplication” of the entangled electrons, one applies separately to whole or part of the preceding “divided” beams, the “secondary” step known as of multiplication of the entanglement defined in the “primary” step of production of an entangled electron beam.
In a “primary” optional step of over-division of one “divided” beam, or of several “divided” beams, one repeats the preceding “primary” step from 1 to 20 times for at least one of the preceding “divided” beam, in order to obtain a large number of over-divided beams containing a large number of entangled electrons.
Finally, in a “primary” step of acceleration of the entangled electrons, one accelerates the entangled electrons, either of the beam of “multiplication” when no division is practiced before, or of one or several “divided” entangled beams when at least one “primary” step of division of the beam of “multiplication” has been applied. One then communicates to the “entangled” electron beams a kinetic energy according to the optimization of the applied process. Then one or several of the accelerated entangled electron beams form the result of the process.

These “primary”, “secondary”, or “tertiary” steps can also include optional additional sub-steps such as some focusing techniques of electron beam, some collimations of electron beam, or some accelerations of electron beams, according to the optimization of the process.

2—In a particular option, the “process of reference” above, to generate, either a collimated beam made up of a spectrum of entangled photons, in whole or in part, and whose photons of each beam themselves are entangled between each other, in whole or in part, can, amongst other things, comprise in complement the following functions:
the Bremsstrahlung effect,
the collimation,

It is characterized by the next steps:
one directs the accelerated entangled electrons, according to the case,
   either from the accelerated entangled electron beam, forming the result of the “referred” process, towards a target, for example of tungsten. By Bremsstrahlung effect a beam containing a spectrum of entangled photons, in whole or in part, composed of gamma, X, ultraviolet, visible, or infrared rays, is produced according to the energy of the primary electrons.
   or from whole or part of the accelerated entangled electron beams, forming the result of the “referred” process, towards one target, or several targets, for example of tungsten, according to the application of the process. By Bremsstrahlung effect, the beams containing a spectrum of entangled photons, in whole or in part, composed of gamma, X, ultraviolet, visible, or infrared rays, according to the energy of the primary electrons are produced.
one positions then one collimator, or several collimators, in the prolongation of the targets to obtain through each collimator, a collimated beam composed of one or of several spectra of entangled photons, according to the irradiation necessary for the use of the device, these collimated beams of entangled photons forming the product of the process.

These last steps can comprise optional additional sub-steps such as some focusing techniques of the beam of photons, when their wavelength allows it, or some complementary collimations of beam of photons, or some combinations of these means, according to the optimization of the process.

3—In another particular option, the “process of reference” numbered 1, is characterized by the kinetic energy communicated by the acceleration of the entangled electrons in the “primary” step of acceleration of the entangled electrons; it is comprised between 1 keV and 10 GeV.

4—In another particular option, the “process of reference” numbered 1, when it is made of “divided” beams going through at least one element of comparable nature according to the same sequence, is characterized by the fact that at least two “divided” electron beams, coming from the beam of “multiplication”, have transit times between homologous elements, for example between cathodes, or photocathodes, and the first dynode, or between dynodes of the same order in the step of additional multiplication, of the same durations, in order to optimize the transfer of the entanglement between the incident entangled electron and the produced entangled electrons.

5—In another particular option, the dependant process numbered 2, is also characterized by the fact that at least two accelerated entangled electron beams have some transit times, between the last dynode having produced the entangled electrons of the aforesaid beams and the targets of incidence of the aforesaid beams exploited by Bremsstrahlung effect, which are of the same durations, in order to optimize the transfer of the entanglement between the incident entangled electrons and the entangled photons, in whole or in part, of types gamma, ultraviolet, visible, or Infrared, which are produced.

6—In another particular option, the “process of reference” numbered 1, to generate two or several entangled beams, in whole or in part, of accelerated electrons, themselves entangled, in whole or in part, between each other in each beam, uses in complement, amongst other things, the generation of entangled beams of ultraviolet, visible or infrared photons. It is characterized in that one carries out the following steps:
one generates two entangled beams of ultraviolet, visible, or infrared photons by means of a nonlinear crystal, for example of BBO or LBO, by illumination by a polarized laser, the aforementioned entangled beams being called “signal” and “idler”, and called by convention the “incident” beams when they do not make the object of a division.
optionally one subdivides one or two of the “signal” or “idler” entangled beams of photons, in one entangled beam, or in several entangled beams, in whole or in part, of photons, themselves entangled, in whole or in part between each other, in each beam, the aforementioned beams, being either the intermediate beams, or the ultimate beams, resulting of one of the division or several of the divisions, the latter being called by convention “incident” beams.
One applies the above “process of reference”, at least twice separately and simultaneously by using at least two of the “incident” beams defined above. At least one of said beams is, either the “signal” beam, or resulting from a division of the “signal” beam, and at least another one is, either the “idler” beam, or resulting from a division of the “idler” beam. Each one of the aforesaid “incident” beams is applied as a beam of ultraviolet, visible, or infrared incident photons to the photocathode of the “secondary” step of generation of electrons in the “primary” step of production of an entangled electron beam in the process. It generates then, either a beam of accelerated entangled electrons, in whole or in part, or several entangled beams, in whole or in part, of accelerated electrons themselves entangled between each other, in whole or in part.

These steps can comprise additional optional sub-steps such as some focusing techniques, or some reflections of the beams of photons, when their wavelength allows it, or of some collimations of the beams of photons, or of some combinations of these means, according to the optimization of the process.

7—In another particular option, the above process, numbered 6, describes how to generate at least two collimated beams entangled, in whole or in part, of photons of types gamma, X, ultraviolet, visible, or infrared, and whose photons of each beam themselves are entangled between each other, in whole or in part, in which one uses in complement, amongst other things:
the Bremsstrahlung effect,
the collimation,

It is characterized in that one carries out the following additional steps:
one directs the accelerated entangled electrons, according to the case,
   either pertaining to the aforesaid entangled and accelerated electron beam, forming the result of the “referred” process, towards a target, for example of Tungsten, which produces, by Bremsstrahlung effect, a spectrum of photons of types gamma, X, ultraviolet, visible, or infrared, which are entangled in whole or in part,
   or pertaining to whole or part of the aforesaid accelerated entangled electron beams, forming the result of the “referred” process, towards one target, or several targets, for example of Tungsten, according to the application of the process, which produce by Bremsstrahlung effect a spectrum of photons of types gamma, X, ultraviolet, visible, or infrared, which are entangled in whole or in part,
one places one collimator, or several collimators, on whole or part of the trajectories of the rays coming from the targets to obtain through each collimator a collimated beam of entangled photons of types gamma, X, ultraviolet, visible, or infrared, according to the irradiation necessary for the use of the device. This or these collimated beams of photons of types gamma, X, ultraviolet, visible, or infrared, which are entangled, form the product of the process.

These steps can comprise optional additional sub-steps such as some focusing techniques of some of the beams of photons, when their wavelength allows it, or such as some complementary collimations of some of the beams of photons, or such as some combinations of these means, according to the optimization of the process.

8—In another particular option, the above process, numbered 7 is, by addition, characterized in that at least two accelerated entangled electron beams have some transit times between the last dynode having produced the aforementioned entangled electrons of the aforesaid beams and the target of incidence exploited by Bremsstrahlung effect for each one of the aforesaid beams, which are of the same durations in order to optimize the transfer of the entanglement between the incident entangled electrons and the photons of types gamma, X, ultraviolet, visible, or infrared, which are entangled in whole or in part, that are produced.

9—In another particular option, the above process, numbered 6, is also characterized by the fact that the transit times of the entangled photons between their generation in the nonlinear crystal, and their incidences on at least two photocathodes, are of same duration in order to optimize the transfer of the entanglement between the entangled incident photons, and the entangled electrons, in whole or in part, which are produced by the aforementioned photocathodes.

10—In another particular option, the application of the whole set of described processes numbered from 1 to 9, is characterized by the fact that whole or part of said process is carried out in a vacuum in order to optimize the transfer of the entanglement in one or more steps or use of said process.

11—The application of the options from 1 to 9 of the description of the process, results in one or several products according to the option used. These products are made up, either by the beam of entangled particles between each other in whole or in part, or by the entangled beams between each other of particles themselves entangled between each other in whole or in part, produced by the process, the beams of particles including either electrons, or photons of types gamma, X, ultraviolet, visible or infrared, or a spectrum of whole or part of these types of photons, according to the option. In the case of one beam of photons, the product contains at least one group of photons entangled between them, produced by the Bremsstrahlung effect, from at least two entangled electrons on one or several targets, aforementioned group of entangled photons with an energy higher than the kinetic energy of one only of the incident electrons on the aforementioned targets or one of the aforementioned targets.

13—The application of each of the options, numbered from 1 to 9, of the description of the process also permits to make an “improved” product which consists of one or more “entangled improved” samples of metastable nuclides. This product can be used, for example, either to irradiate the environment, or to build a laser gamma, or to conduct physicochemical reactions, or to remotely communicate, or for a medical use.

14—For the application of all the options, numbered from 1 to 9, of the description of the process, an intermediate or final product made up, either by the beam of particles entangled between each other, or by the beams entangled between them of particles themselves entangled between each other, can be produced by the process by using metastable nuclides. These beams of particles made of, either of the electrons, or of the photons of types gamma, X, ultraviolet, visible or infrared, or a spectrum of whole or part of these types of photons. This product can be used for a medical use.

15—The man of the art can generalize the teaching of this description to all processes for generating, either an accelerated entangled electron beam, in whole or in part, or several accelerated entangled electron beams, in whole or in part, the accelerated electrons themselves being entangled between them, in whole or in part, characterized in that the method includes, in association, at least the following steps:
a step of generation, either of a free electron beam, or of two free electron beams entangled between them, in whole or in part,
a step of multiplication of the produced electrons of one free electron beams or of several free electron beams, in which one generates, by means of one or several groups of dynodes, one or more beams of multiplication made up of free entangled electrons in whole or in part,
a step of acceleration of the free entangled electrons in whole or in part, in which one accelerates whole or part of the electrons, of the beams of multiplication or some of the beams of multiplication when they are not divided, and of one or several beams of multiplication divided when a splitting of the
beams of multiplication or some of the beams of multiplication was implemented, in which one communicates to the electrons of the beam or of the beams, a kinetic energy according to the optimization of the method of implementation to obtain either an accelerated entangled electron beam, in whole or in part, or several entangled accelerated electron beams, in whole or in part, the accelerated electrons themselves being entangled between them, in whole or in part.

16—In a particular option, the process of the step of multiplication of the electrons of at least one of the generated free electron beams, is implemented in one or more intermediate stages, composed each one of a dynode, forming a multiplier of electrons, in which one directs free electrons towards a first dynode, then towards the dynodes of the following optional stage according to the optimization of the method, the impact of at least one electron on at least one of the dynodes causing the emission of several electrons emitted simultaneously, or in a fast cascade, therefore entangled in whole or in part between them, and if the primary electron itself is entangled with another electron, with one partial or total transfer of the entanglement of the primary electron to the electrons emitted at the time of the impact on the dynode, the step ending in an exit of the electrons in a last stage of the multiplier of electrons, in which one directs the generated electrons, entangled in whole or in part, towards a non-collecting anode, called by convention “electrode” of the step, whose potential is higher than the last dynode encountered, the anode containing for example, either an opening in its center, or still an ad hoc grid, the anode not collecting the electrons, and letting the free electrons pass, in whole or in part, to form the beam of multiplication,

17—In a particular option, the process in which one uses some divided beams of multiplication, characterized in that at least two of the divided beams of multiplication have some transit times between the homologous elements with the same durations.

18—In a particular option, the process in the step of generation contains two free electron beams, entangled between them, in whole or in part, each one produced by means of a photocathode irradiated or illuminated by one of the entangled beams of ultraviolet, visible or infra-red photons, named “Signal” and “Idler”, obtained by means of a nonlinear crystal, for example of BBO or LBO, by illumination by means of a polarized laser, the entangled beams being called by convention the “incident” beams, the incident beams and the photocathodes being appropriate for the photoemission, the photocathodes transmitting the possible entanglement of the photons of the incident beams to the generated free electrons to form the generated free electron beams entangled between them, in whole or in part.

19—In a particular option, the process in the step of generation is designed such as the transit times of the entangled photons between their generation in the nonlinear crystal, and their striking of the two photocathodes, are of the same durations in order to optimize the transfer of the entanglement between the incident entangled photons, and the generated free electrons by the photocathodes to form the generated free electron beams.

20—In a particular option of the step of generation, the process is designed such as the transit times of the two free electron beams generated between the photocathodes and the striking of the first dynodes, and also, between the successive dynodes, are of the same durations in order to optimize the transfers of entanglement between the incident entangled electron and the entangled electrons generated by the aforementioned dynodes.

21—In a particular option, one uses of the process to generate, either a beam made up of a spectrum of photons gamma, X, ultraviolet, visible or infra-red, entangled in whole or in part, or several entangled beams, in whole or in part, composed of a spectrum of photons gamma, X, ultraviolet, visible or infra-red whose photons of each beam are themselves entangled between them, in whole or in part, characterized in that one directs the accelerated entangled electrons, according to case's:
either the accelerated entangled electron beam, forming the result of the referred process, towards a target which produces, by Bremsstrahlung effect, a beam containing a spectrum of entangled photons, in whole or in part, composed of gamma, X, ultraviolet rays, visible or infra-red photons, according to the energy of the incident electrons,
either the entangled accelerated electron beams, in whole or in part, and forming the result of the referred process, towards one or more targets which produce, by Bremsstrahlung effect, one or more beams themselves entangled between them, in whole or in part, containing a spectrum of entangled photons, in whole or in part, composed of gamma, X, ultraviolet, visible or infra-red, according to the energy of the incident electrons, whose photons of each beam are themselves entangled between them, in whole or in part.

22—In a particular option the use that includes at least two accelerated entangled electron beams must have transit times, between the exit of the step of acceleration and the incidence on the target exploited with the Bremsstrahlung effect for each one of the aforesaid beams, which are of the same durations in order to optimize the transfer of the entanglement between the incident entangled electrons on the targets and the produced photons gamma, ultraviolet, visible or infra-red that are entangled, in whole or in part.

23—The device for the implementation of the process includes:
one or more apparatuses of generation of free electrons especially adapted to the step of generation of the free electrons,
one or more apparatuses of multiplication of the free electrons especially adapted to the step of multiplication of the free electrons,
one or more apparatuses of acceleration of the free electrons especially adapted to the step of acceleration of the free electrons.

24—In a particular option the device mentioned above includes:
an apparatus of generation of the free electrons (47) especially adapted to the step of generation of the free electrons,
an apparatus of multiplication of the free electrons (48) especially adapted to the step of multiplication of the free electrons,
an apparatus of acceleration of the free electrons (49) especially adapted to the step of acceleration of the free electrons,

The accelerated free electrons at the exit of the aforesaid apparatus of acceleration forming the beam (50) of accelerated entangled electrons, in whole or in part.

25—In a particular option the device mentioned above includes:
an apparatus of generation of the free electrons (47) especially adapted to the step of generation of the free electrons,
an apparatus of multiplication (48) of the free electrons especially adapted to the step of multiplication of the free electrons,
an apparatus (84) for the splitting of the beam of multiplication (85) especially adapted for proceeding to the step of acceleration of the free electrons, to produce the divided beams of multiplication (86, 87),
two or several apparatuses of acceleration (88, 89) of the free electrons especially adapted to the aforementioned step of acceleration of the free electrons,

The accelerated free electrons at the exit of the apparatus of acceleration forming then the beam (90, 91) of accelerated entangled electrons, in whole or in part, the accelerated electrons being themselves entangled between them, in whole or in part.

26—In a particular option, the device mentioned above includes:
an apparatus of generation especially adapted to the step of generation of the free electrons, which brings forth two generated free electron beams each one by means of a photocathode (35, 36) irradiated or illuminated by one of the entangled beams (29, 30) of ultraviolet, visible or infra-red photons, named “Signal” and “Idler”, obtained by means of a nonlinear crystal (28), for example of BBO or LBO, by illumination by means of a laser (26) fitted with a polarizer (27), the aforementioned entangled beams being called by convention “incident” beams, the aforementioned incident beams and the aforementioned photocathodes being appropriate for the photoemission, the photocathodes transmitting the possible entanglement of the photons of the incident beams to the aforesaid free electrons generated to form the generated free electron beams, entangled between them, in whole or in part,
two apparatuses of multiplication (37, 38) of the free electrons especially adapted to the aforementioned step of multiplication of the free electrons,
two apparatuses of acceleration (39, 40) of the free electrons especially adapted to the aforementioned step of acceleration of the free electrons,

The accelerated free electrons at the exit of the apparatus of acceleration forming then the beam (112,113) of accelerated entangled electrons, in whole or in part, the accelerated electrons being themselves entangled between them, in whole or in part.

### SUMMARY DESCRIPTION OF THE DRAWINGS

FIG. 1 represents the diagram of the use of a non-linear crystal to obtain two entangled beams of photons of light. (According to Kurtsiefer C., Oberparleiter M., and Weinfurter H., <<Generation of correlated photon pairs in type II parametric down conversion—revisited>> Feb. 7, 2001, submitted J. Mod. Opt.)

FIG. 2 schematically represents the process of multiplication of the electrons in a photomultiplier, (According to Ralph W. Engstrom, “Photomultipliers Handbook”).

FIG. 3 schematically represents a linear accelerator containing a Tungsten target to emit a spectrum of photons of types gamma and X.

FIG. 4 shows the typical spectrum of photons of types gamma and X emitted by a linear accelerator of CLINAC type. (According to Sameer S. A. Natto, Belal Moftah, and Noor M. H. Ghassal, Journal of Australian Physical & Engineering Sciences in Medicine, 26, 3, pp 78-82, 2003).

FIG. 5 represents the overall diagram of a version of the apparatus object of the invention. This apparatus generates two entangled beams of rays of types gamma, X, ultraviolet rays, visible, or infrared, themselves partially entangled.

FIG. 6 represents the typical diagram of a generator of entangled electrons.

FIG. 7 represents the diagram of a generator of photoelectrons by transparency.

FIG. 8 represents the diagram of a generator of photoelectrons by reflection.

FIG. 9 represents the diagram of an amplifier of the number of electrons made up of dynodes.

FIG. 10 represents the diagram of an accelerator of electrons of the linear type.

FIG. 11 represents the typical diagram of a generator of rays of types infrared, visible, ultraviolet, X, or gamma, entangled by using a target in which the effect of Bremsstrahlung produces the aforementioned rays. These rays are collimated.

FIG. 12 represents the diagram of the process of Bremsstrahlung in a target in which the primary electrons generate entangled rays of types infrared, visible, ultraviolet, X, or gamma.

FIG. 13 illustrates the case where the outgoing electron beam of the multiplier of electrons is divided into two beams. Each beam is then sent towards the accelerator to emit electrons of high energy, which are used as such.

FIG. 14 illustrates the case where the outgoing electron beam of the multiplier of electrons is divided into two beams. Each beam is then sent towards the accelerator to emit electrons of high energy. The aforementioned electrons then strike a target to generate entangled rays of types infrared, visible, ultraviolet, X, or gamma.

FIG. 15 illustrates an alternative of FIG. 13, in which the divided beams are directed towards a multiplier of electrons before entering the accelerator to emit electrons of high energy, which are used as such.

FIG. 16 illustrates an alternative of FIG. 15 in which the divided beams are directed towards multipliers of electrons before entering the accelerators to emit electrons of high energy. The aforementioned electrons then strike the targets to generate entangled rays of types infrared, visible, ultraviolet, X, or gamma.

FIG. 17 illustrates an alternative of FIG. 5 in which the entangled electron beams at the exit of the multipliers of electrons are used as such to irradiate, for example, thermoluminescent samples.

FIG. 18 illustrates an alternative of FIG. 17 in which the entangled electron beams at the exit of the multipliers of electrons are focused to irradiate very small surfaces.

FIG. 19 illustrates an alternative of FIG. 17 in which the photoelectrons coming from the photocathode are admitted directly in the module of acceleration to produce two entangled electron beams.

FIG. 20 illustrates an alternative of FIG. 5 in which the photoelectrons coming from the photocathode are admitted directly in the module of acceleration to produce two beams of gamma rays.

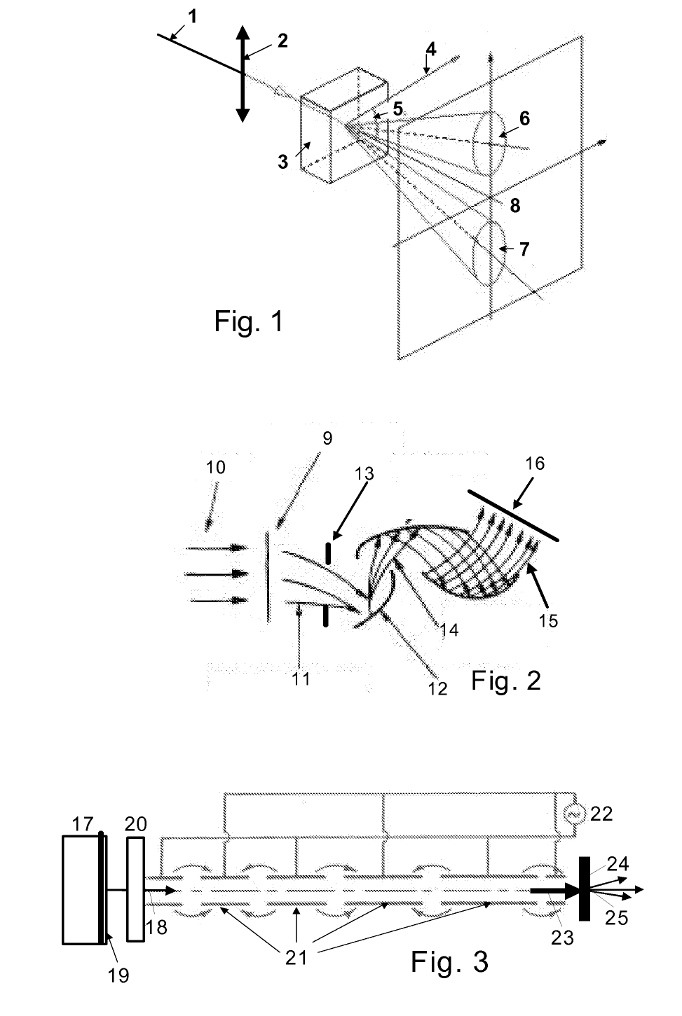

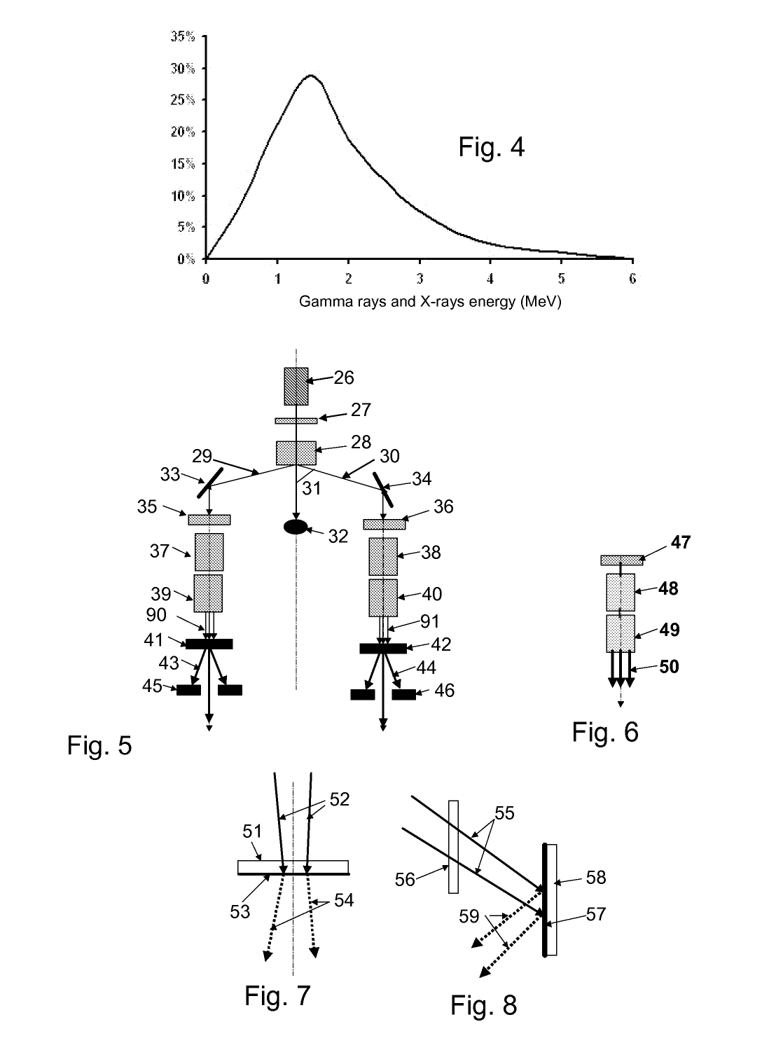

### MANNERS OF IMPLEMENTING THE INVENTION

Manners of implementing the invention are described below. However, it is specified that the present invention can be implemented in various ways. Thus the specific details mentioned below should not be understood as limiting the implementation, but rather as a descriptive basis to support the claims and to teach the man skilled in the art the use of the present invention in practically the totality of the systems, structures, or detailed and suitable ways.

FIG. 6 represents a module of transformation of the photons into an entangled electron beam. The element (47) represents a generator of electrons of weak energy, for example from 1 to 10 eV. The aforementioned generator can be a photocathode or a hot filament. A first type of photocathode is illustrated on FIG. 7. A transparent window (51) is struck by the photons (52) which meet the sensitive layer (53). The aforementioned sensitive layer emits the electrons (54) according to the explanation which was provided previously. The electrons can also be emitted by a cathode by reflection as indicated on FIG. 8. In this case, the photons (55) strike a window (56) to touch the sensitive layer (57) laid, for example, to the wall (58) and to emit the electrons (59).

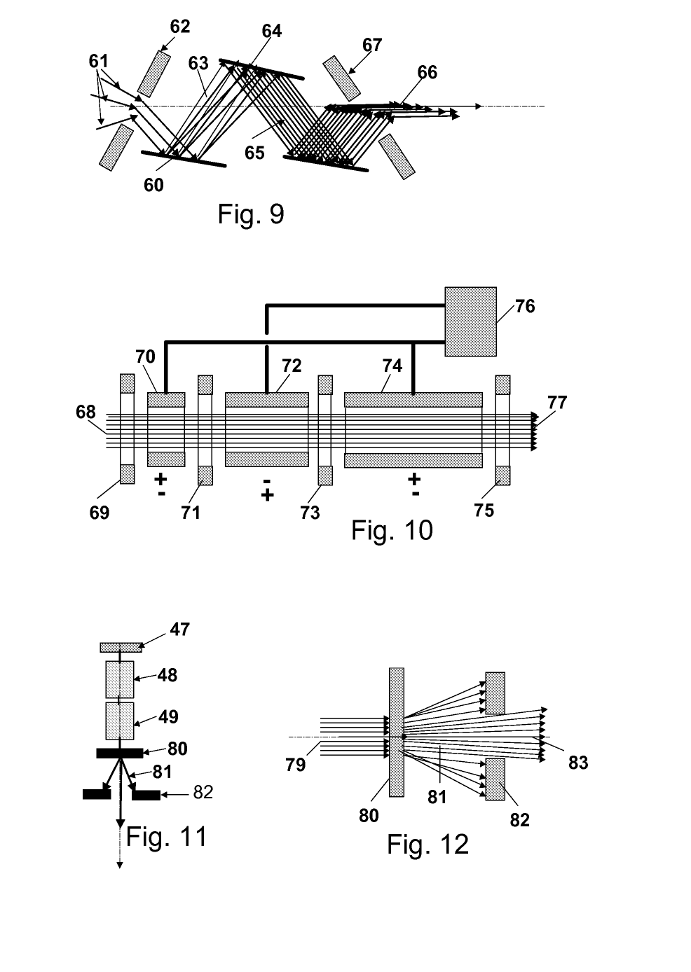

The electrons (61) are then attracted by the dynode (60) of the multiplying module of electrons represented on FIG. 9. The aforementioned module is labeled (48) on FIG. 6. The aforementioned dynode (60) has a potential higher than that of cathode, for example of 100 V, to create an electric field and to accelerate the electrons as explained previously. An electrode or coil of focusing (62) can be used to focus the electrons. Several entangled electrons (63) are emitted by the impact of each electron as shown in the FIG. 9. The same phenomenon reproduces on the following dynodes, as is shown, the dynode (64) x emits the entangled electrons (65). Finally, the beam of the last dynode is focused by an electrode or coil (67) to form the beam (66), which will be admitted into the following module.

The following module, referred (49) on FIG. 6, is the module of acceleration of the electrons. FIG. 10 is a diagram of this module. The electrons of the beam (68), coming from the multiplier module, are admitted through a focusing ring (69) towards an electrode (70) of very high potential, for example of 100000 V. They thus are strongly accelerated and continue their path through the electrode (70) to be re-focused by the ring (71) whereas a new very high potential is applied in the ad hoc direction by the generator (76) between the electrodes (70) and (72) to continuously increase the speed of the electrons. The process is repeated with the focalizer (73), (75) and following, as well as with the electrodes (74) and following, to the exit of the beam of entangled electron of great energy (77). This beam can be used as such for different applications. It can also be sent on a target as FIG. 11 shows it.

FIG. 11 is identical to FIG. 6 with the addition of a target (80) and of a collimator (82) to collimate the rays (81) emitted by Bremsstrahlung.

On FIG. 12, the accelerated beam of entangled electrons (79) is represented. These electrons strike the target (80), for example of Tungsten, from which are emitted the entangled rays, for example the gamma (81). The aforementioned entangled rays are then collimated by the collimator (82) to provide a beam (83) with the dimensions necessary for the applications.

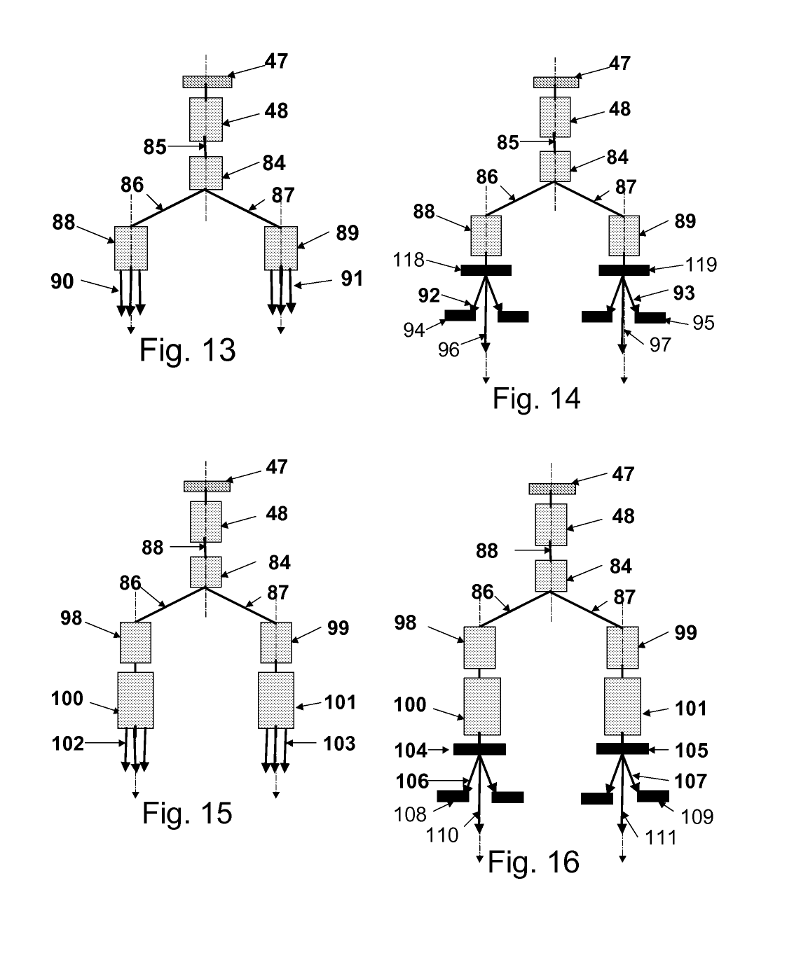

On FIG. 13, one finds the generator of electrons (47), the multiplier of electrons (48), which generates the entangled electrons (85), and the divider of beam (84), which statistically divides the entangled electrons into two beams (86) and (87). These beams are then admitted into two accelerators of electrons (88) and (89) similar to that described previously. Two electron beams, (90) and (91), of high energy come out and contain of groups of entangled electrons between each other and entangled beam to beam. The aforementioned beams can then be used as such for various applications. The entangled beams of electrons can also be used as shown in the FIG. 14. Two targets (118) and (119) are positioned on the path of the electrons of high energy leaving the accelerator. By Bremsstrahlung effect, two beams of entangled gamma (92) and (93), for example, are emitted. The aforementioned gamma are collimated by the collimators (94) and (95). The collimated beams (96) and (97) can then be used for various applications.

An alternative of implementation of the preceding is represented on FIG. 15. In the aforementioned alternative, the beams (86) and (87) coming from the divider of beam are sent on two other multipliers of electrons (98) and (99), which increase the number of entangled electrons in each branch. The aforementioned electrons are then accelerated in the accelerators (100) and (101). The entangled electron beams (102) and (103) are then used as such for various applications.

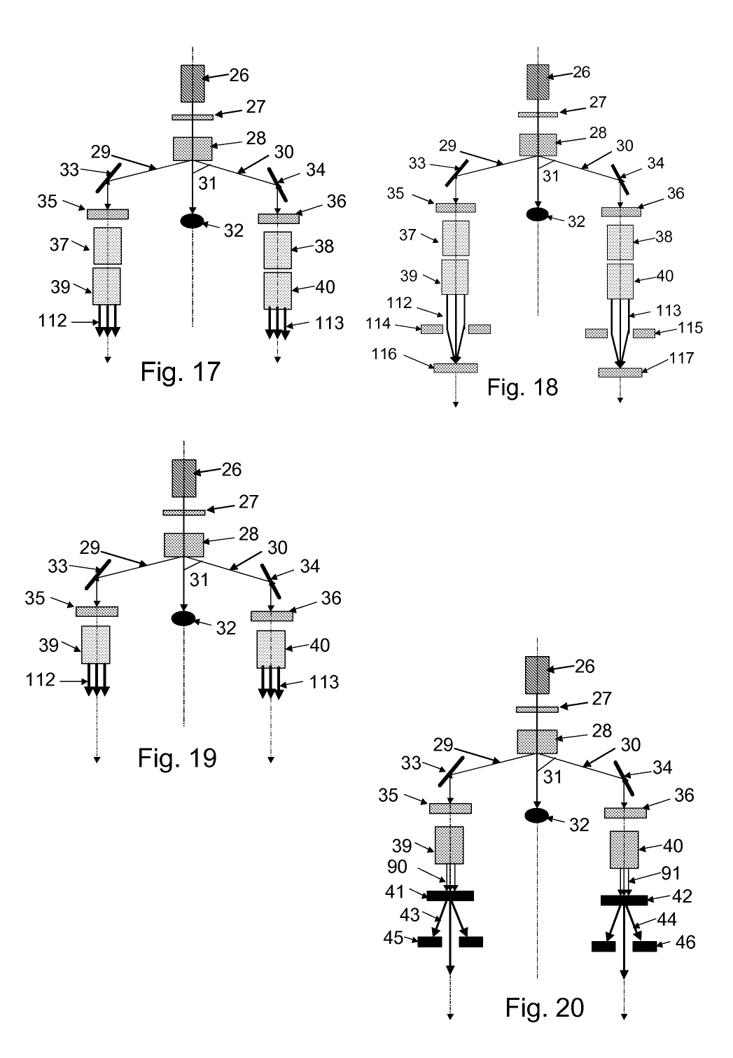

A use of the aforesaid entangled beams is represented on FIG. 16. The aforementioned Figure contains the elements of FIG. 15 and two targets (104) and (105) positioned on the path of the electrons of high power leaving the accelerator. By Bremsstrahlung effect, two beams of entangled gamma (106) and (107), for example, are emitted. The aforementioned gamma are collimated by the collimators (108) and (109). The collimated beams (110) and (111) can then be used for various applications. FIG. 17 is a simplified version of FIG. 5, in which the entangled electron beams (112) and (113) as such for various applications.

FIG. 18 represents a particular version of FIG. 17. In FIG. 18, a focusing of the entangled electrons of high energy is made, for example, by using some magnetic lenses (114) and (115) in order to obtain entangled beams covering ad hoc surfaces, for example a square micrometer to a square millimeter on the target-samples (116) and (117). The non focused beams can cover larger surfaces, for example a square meter to one square decimeter. The same device for focusing is also applicable to the beams produced on FIGS. 13 and 15.

FIG. 19 is a simplified version of FIG. 5 in which the photoelectrons emitted by the photocathode are admitted in the accelerating module, and the entangled electron beams (112) and (113) are used as such for various implementations.

FIG. 20 is another simplified version of FIG. 5 in which the photoelectrons emitted by the photocathode are admitted in the accelerating module, and the entangled electron beams (90) and (91) are directed on targets (41) and (42) in order to produce, by Bremsstrahlung effect, the beams of X-rays or gamma rays (43) and (44) to be used after being delimited by the windows (45) and (46).

### Better Manner of Implementing the Invention:

FIG. 5 represents the best manner of implementing the invention.

A laser (26) emits a beam of rays of light with a wavelength from 110 to 800 nm according to the wavelength chosen for the entangled photons (29) and (30). For the low wavelengths a laser of type excimer is used. A polarizer (27) is used to obtain the polarization in a plan so that the entangled beams (29) and (30) are emitted in a plan. The polarized beam is sent on a non-linear crystal, of type BBO or LBO or any other nonlinear material. The crystals used at present have very poor yield of about 1/10⁺²⁰. More efficient crystals are in the course of evaluation. In the optimal orientation, three beams are emitted by the crystal: a direct beam, non-disturbed, which leaves in the direction the incident beam; and two entangled beams (29) and (30) called “signal” and “idler” according to the usual convention. The aforementioned beams form an angle (31) with the principal beam, non-disturbed, which is absorbed by the “phantom” (32). The above beams are reflected by the mirrors (33) and (34) to go in the direction of the following modules or these beams use optical fibers.

The converters of photons in electrons (35) and (36), for example, consist of a photo-emissive layer, the photocathode, which absorbs the photons and transmits their energy to the electrons, which are emitted by the aforementioned layer with the energy mentioned previously. The photocathode is placed in a vacuum enclosure. The emission of electrons can be done in the direction of the incident photons (52) as shown in FIG. 7 or by a reflection as shown in FIG. 8.

In FIG. 7, the incidental photons (52) cross the transparent window (51) before meeting the semi-transparent photocathode (53), for example of 20 nm thickness, and for example composed of materials such as Tellurium, Gallium, Antimony, Arsenic, etc. The electrons (54) are emitted roughly in the direction of the incidental photons. In this case, the effectiveness of the cathode does not exceed 50%.

In FIG. 8, the thickness of the photocathode (57) is more important than that of FIG. 7, about a micrometer and the photons (55) are admitted in an evacuated enclosure by the window (56). They meet the photocathode, which is laid on the support (58). The emitted electrons (59) are reflected as shown in the FIG. 8. The effectiveness of the aforesaid photocathode is slightly higher than that of FIG. 7.

The multipliers of the number of electrons (37) and (38), for example made up of dynodes, are represented on FIG. 9. The electrons (61) coming from the photocathode are focused, for example by a magnetic lens (62), so that they reach the first dynode (60). They cause the emission of a greater number of secondary electrons (63), which meet the second dynode (64). Many more electrons (65) are produced to meet the following dynode, and so on, until the last dynode whose electrons are focused, for example by means of a magnetic lens (67), to form an axial electron beam (66), which is injected into the following module.

The accelerating modules of electrons (39) and (40), for example linear accelerators, are schematically represented on FIG. 10. The incident electrons from the beam (68) are introduced into the first electrodes of acceleration (70) after a possible passage in a magnetic lens (69), for example, in order to focus the electrons. If required, lenses, for example of magnetic type (71), (73), are used for re-focusing the electron beam, between electrodes, and at the exit of the beam. The electrodes (70), (72), (74) and others, since three only are represented, are alternatively brought to positive and negative potentials, in order to accelerate the electrons in the intervals. The aforementioned electrodes are powered by a generator of AC current (76) at very high frequency. Finally, the electron beam (77) leaves the accelerator after, for example, a last focusing by the magnetic lens (75).

In FIG. 5, the entangled electrons (90) and (91) are then thrown to the targets (41) and (42) which, by Bremsstrahlung effect, produce entangled rays of types infrared, visible, ultraviolet, X, or gamma (43) and (44), according to the type of target and the energy of the electrons.

FIG. 12 schematically shows the generation of the infrared, visible, ultraviolet, X, or gamma rays, by Bremsstrahlung effect. The electron beam of great energy (79) strikes a target (80) of heavy metal, for example, of Tungsten for producing gamma rays. A spectrum of entangled rays of types gamma and X (81) is produced primarily in the direction of the electrons, however a collimator (82) is used to obtain a beam (83) only in the chosen area, generally called isocenter. The infrared, visible, ultraviolet, X, or gamma rays obtained are partially entangled between each other and with the infrared, visible, ultraviolet, X, or corresponding gamma rays of the other branch of the system.

To obtain entangled X-rays, the accelerator of electrons operates with an electric voltage, for example of 100 kV, to generate a spectrum of entangled X-rays centered on approximately 30 keV. As previously, the X-rays obtained are partially entangled between each other and with the corresponding X-rays of the other branch of the system. To obtain entangled rays of type infrared, visible, or ultraviolet, the accelerator of electrons operates with an electric voltage, for example of 25 kV, to generate a spectrum of entangled infrared, visible, or ultraviolet rays generally centered on a wavelength depending on the selected fluorescent material. As previously, the infrared, visible or ultraviolet rays obtained are partially entangled between each other and with the corresponding infrared, visible or ultraviolet rays of the other branch of the system. The amplification of the intensity of the obtained beam of photons partially entangled between each other and entangled with the corresponding photons of the other branch, compared to the beams produced by the non-linear crystal, is about 3000 to 100000.

### POSSIBILITIES OF INDUSTRIAL APPLICATIONS

The multiple uses of the referred process and all its complements and options are listed and numbered below:

1—Use of the process according to any of the modes of implementation of the process characterized in that the process is used to bombard or irradiate compounds made up of substances in the form solid, liquid, or gas, or composed of a combination of these substances.

2—Use according to paragraph 1 characterized in that the process is implemented, either with focused or collimated electron beams, or with beams of photons, collimated or focused when their wavelength allows for, in order to bombard, irradiate or illuminate one or more surfaces of the aforesaid compounds, of surfaces ranging between 1000 square nanometers and a square decimeter.

3—Use according to paragraph 1, characterized in that one transfers the entanglement from the particles contained in the beam or the beams, produced by the process, to compounds made up of substances in solid, liquid, or gas form, or composed of a combination of these substances, called by convention “samples”, either to introduce the typical property of entanglement between trapped photons, trapped electrons, excited atoms, excited nuclei, excited molecules, excited micelles, present in one or more “samples” that are bombarded or irradiated by means of one or several of the beams of particles, or to introduce the typical property of entanglement between trapped photons, trapped electrons, excited atoms, excited nuclei, excited molecules, excited micelles, contained in separate “samples” bombarded or irradiated by means of two or several of the entangled beams, in whole or part, of particles themselves entangled in whole or part, the beams of particles either made of the electrons, or of the photons of types gamma, X, ultraviolet, visible or infrared, or a spectrum of whole or part of these types of photons, the “samples”, which are the result of the use of the process being called by convention improved “entangled” samples.

4—Use according to paragraph 3, characterized in the following: When the beams of bombardment or irradiation are composed of electrons, at least two accelerated entangled electron beams comprise transit times, between the last electrode having produced the entangled electrons of the beams and the “samples” to be bombarded by each the beams, which are of same durations in order to optimize the transfer of the entanglement between the incident entangled electrons and the ad hoc components of the “samples”. When the beams of bombardment or irradiation are composed of photons of types gamma, X, ultraviolet, visible or Infrared, or composed of a spectrum of whole or part of these types photons, at least two beams of entangled photons comprises transit times, between the target having produced by Bremsstrahlung effect the entangled photons, and the “samples” to irradiate by each beam, which are of the same duration in order to optimize the transfer of the entanglement between the incident entangled photons and the ad hoc components of the “samples”. The samples form the improved “entangled” samples.

6—Use according to paragraph 1, characterized in that the process is used to produce, either a beam of entangled particles between each other that one makes interfere between each other, or some beams of particles entangled between each other themselves entangled between each other that one makes interfere between each other, for example as an applications for electronic microscopy or engraving in nanotechnology, The beams of particles are made up either of electrons, or of photons of types gamma, X, ultraviolet, visible or infrared, or a spectrum of everyone or a part of these types of photons.

7—Use according to paragraph 3, characterized in that the process is used to bombard or irradiate one or more “samples containing isomer nuclide, for example Niobium (93Nb41m), Cadmium (111Cd48m), Cadmium (113Cd48m), Cesium (135Ce55m), Indium (115In49m), Tin (117Sn50m), Tin (119Sn50m), Tellurium (125Te52m), Xenon (129Xe54m), Xenon (131Xe54m), Hafnium (178Hf72m), Hafnium (179Hf72m), Iridium (193Ir77m), Platinum (195Pt78m), in order to induce the property of entanglement in at least one group of more than 100 nuclei of the of nuclide entangled between each other, either in only one “sample”, which is the “improved entangled” sample, or distributed in several samples, which makes the “improved entangled” samples.

8—Improved use according to paragraph 7 characterized in that one exploits later at least one “improved entangled” sample, according to any of the uses of the “entangled sample” of patent WO 2005/109985[8], by substituting the “entangled” sample of the patent by an “improved entangled” sample, including the uses as published initially and as modified under the terms of the article 19 of the PCT and of the international preliminary examination.

9—Improved use according to paragraph 7, characterized in that one exploits later on at least one “improved entangled” sample, by natural deexcitation, characterized in that the sample is used as a radiation source of gamma radiation to irradiate its environment, the sample comprising at least one nuclide of variable half-life of natural deexcitation, initially lower than 50% of the theoretical half-life of the aforesaid nuclide.

10—Improved use according to paragraph 7 characterized in that one later on exploits at least one “improved entangled” sample, by stimulation by means of X-rays, characterized in that the entangled “improved sample” which contains at least 5% of the nuclei excited and entangled in the improved “entangled sample”, of the nuclide contained in the “improved entangled” sample, is used as a practically instantaneous gamma radiation source (“prompt”) to irradiate its environment or to be used in a gamma laser, while being deexcited in less than one second and in producing the gamma radiation of the excited nuclide.

11—Improved use according to paragraph 7 characterized in that one later on exploits at least two entangled “samples improved”, according to any of the uses of “entangled samples” of patent WO 2005/112041[9] by substituting “entangled” samples in the patent by “improved entangled” samples, including the uses as initially published and as modified under the terms of article 19 of the PCT and of the international preliminary examination.

12—Improved use according to paragraph 7 characterized in that one later on exploits at least two “improved entangled” samples characterized in that one carries out the following steps:
one separates in space whole or part of the “improved entangled” samples containing excited nuclei of the nuclide presenting some quantum connections, some of the excited nuclei of the nuclide being distributed on some of these “improved entangled” samples, and presenting some groups of more than 100 quantum connections,
one exploits some quantum couplings between excited nuclei of some “improved entangled” samples, independently of the distances, of the mediums separating them, and of the mediums in which these “improved entangled” samples are placed:
   by causing at least one modulated stimulation of the deexcitation by X or gamma irradiation, for example obtained by means of a source of Iron 55, of at least one “improved entangled” sample, qualified “master” “improved entangled” sample, the modulated stimulation, inducing, by means of quantum couplings, a remote deexcitation of the other “improved entangled” samples, qualified “slaves” “improved entangled” samples, the aforesaid modulated stimulation applied to the “master” sample characterizing at least one information or at least one command to transmit,
   And, either by determining, either at least one detection of information, or at least one detection of command, by means of at least one measurement made with a detector of gamma radiation, of at least one additional modulated deexcitation on at least one line characteristic of at least one isomer nuclide contained in at least one of the other “slave” “improved entangled” samples, or by using the gamma radiation resulting from the additional modulated deexcitation of at least one isomer nuclide contained in at least one of the other “slave” “improved entangled” samples, as a remote control, or by using at least one other “slave” “improved entangled” samples, as a product of which the irradiation is operated by remote control to irradiate the environment of the aforesaid “improved entangled” “slave” sample, or to build a remotely controlled gamma laser, or for a combination of these exploitations.

13—Improved use according to paragraph 3 characterized in that the “samples” made of at least one thermoluminescent or photoluminescent material, and in that one later on exploits at least two “improved entangled” samples, according to any of the uses of “entangled samples” of patent WO 2005/117306[10] in substituting “entangled” samples of the patent by “improved entangled” samples, including the uses as published initially and as modified under the terms of the article 19 of the PCT and of the international preliminary examination.

14—Improved use according to paragraph 3 characterized in that the samples containing at least one thermoluminescent or photoluminescent material, and in that one later on exploits at least two “improved entangled” samples, by carrying out the following steps:
One separates in space whole or part of these “improved entangled” samples containing entangled electrons in traps of thermoluminescent or photoluminescent materials, some of the trapped electrons being distributed on certain of these samples, and presenting quantum connections,
One exploits some quantum couplings between the trapped electrons of these “improved entangled” samples, independently of the distances, the mediums separating them and the mediums in which they are placed:
By causing at least one modulated stimulation in amplitude and/or in frequency on at least one of the aforesaid “improved entangled” samples, qualified of “master”, for example either by heating in its totality, or by heating at least one dot of its surface, or by optical stimulation using at least one flash of infrared, visible, or ultraviolet light on its totality, or by optical stimulation using at least one flash of infrared, visible or ultraviolet light in at least one dot of its surface, or by a combination of these processes, the modulated stimulation characterizing an information or a command to be transmitted,
and in determining, either at least a detection of information, or at least a detection of order, by means of at least one measurement made with a detector of luminescence, for example a photomultiplier or a photodiode, of at least a variation of luminescence on at least a kind of thermoluminescent or photoluminescent materials contained in at least one of the other “improved entangled” samples, qualified of “slave”, when the variation of the measured luminescence is partially correlated with the modulated stimulation applied to the “master” sample.

1) Method to generate, either one accelerated entangled electron beam, in whole or in part, or several accelerated entangled electron beams, in whole or in part, the aforementioned accelerated electrons themselves being entangled between each other, in whole or in part, characterized in that the method includes, in association, at least the following steps:
(a) step of generation, either of a free electron beam, or of two free electron beams entangled between each other, in whole or in part,
(b) step of multiplication of the produced electrons of the aforesaid free electron beam, or of several aforesaid free electron beams, in which one generates, by means of one group, or several groups, of dynodes, one beam, or several beams, of multiplication made up of free entangled electrons in whole or in part,
(c) step of acceleration of the free entangled electrons in whole or in part, in which one accelerates whole or part of the aforesaid electrons, of the aforesaid beam of multiplication, or of some of the aforesaid beams of multiplication, when they are not divided, and of one divided beam, or several divided beams, of multiplication, when a splitting of the aforesaid beam of multiplication, or some of the aforesaid beams of multiplication was implemented, in which one communicates to the electrons of the aforesaid beam, or of the aforesaid beams, a kinetic energy according to the optimization of the method of implementation to obtain either an accelerated entangled electron beam, in whole or in part, or several entangled accelerated electron beams, in whole or in part, the aforementioned accelerated electrons themselves being entangled between each other, in whole or in part.

2) Method according to claim 1 characterized in that the aforementioned step of multiplication of the electrons of the aforesaid generated free electron beam, or of at least one of the aforesaid generated free electron beams, is implemented in one intermediate stage, or several intermediate stages, composed each one of a dynode, forming a multiplier of electrons, in which one directs free electrons towards a first dynode, then towards the dynodes of the following optional stages according to the optimization of the method, the impact of at least one electron on at least one of the aforesaid dynodes causing the emission of several electrons emitted simultaneously, or in a fast cascade, therefore entangled in whole or in part between each other, and if the primary electron itself is entangled with another electron, with one partial transfer, or the total transfer, of the entanglement of the primary electron to the electrons emitted at the time of the impact on the aforementioned dynode, the aforementioned step ending in an exit of the electrons in a last stage of the multiplier of electrons, in which one directs the generated electrons, entangled in whole or in part, towards a non-collecting anode, called by convention “electrode” of the step, whose potential is higher than the last dynode encountered, the aforementioned anode containing for example, either an opening in its center, or an ad hoc grid, the aforementioned anode not collecting the aforementioned electrons, and letting the aforesaid free electrons pass, in whole or in part, to form the aforementioned beam of multiplication,

3) Method according to claim 1 in which one uses some divided beams of multiplication, characterized in that at least two of the aforesaid divided beams of multiplication have some transit times between the homologous elements with the same durations.

4) Method according to claim 1 characterized in that the aforementioned step of generation contains two free electron beams, entangled between each other, in whole or in part, each one produced by means of a photocathode irradiated, or illuminated, by one of the entangled beams of ultraviolet, visible, or infra-red photons, named “Signal” and “Idler”, obtained by means of a nonlinear crystal, for example of BBO or LBO, by illumination by means of a polarized laser, the aforementioned entangled beams being called by convention the “incident” beams, the aforementioned incident beams and the aforementioned photocathodes being appropriate for the photoemission, the aforementioned photocathodes transmitting the possible entanglement of the aforesaid photons of the aforesaid incident beams to the generated free electrons to form the aforementioned generated free electron beams entangled between each other, in whole or in part.

5) Method according to claim of method 4, characterized in that the transit times of the entangled photons between their generation in the nonlinear crystal, and their striking of the two photocathodes, are of the same durations in order to optimize the transfer of the entanglement between the incident entangled photons, and the generated free electrons by the aforementioned photocathodes to form the aforementioned generated free electron beams.

6) Method according to claim of method 4, characterized in that the transit times of the two free electron beams generated between the photocathodes and the striking of the first dynodes, and also, between the successive dynodes, are of the same durations in order to optimize the transfers of entanglement between the incident entangled electron and the entangled electrons generated by the aforementioned dynodes.

7) Method according to claim 1, called in the continuation the referred method, to generate, either a beam made up of a spectrum of photons gamma, X, ultraviolet, visible, or infra-red, entangled in whole or in part, or several entangled beams, in whole or in part, composed of a spectrum of photons gamma, X, ultraviolet, visible, or infra-red, whose photons of each beam are themselves entangled between each other, in whole or in part, characterized in that one directs the accelerated entangled electrons, according to the case:
either the aforesaid accelerated entangled electron beam, forming the result of the referred method, towards a target which produces, by Bremsstrahlung effect, a beam containing a spectrum of entangled photons, in whole or in part, composed of gamma, X, ultraviolet rays, visible, or infra-red photons, according to the energy of the incident electrons,
either the aforesaid entangled accelerated electron beams, in whole or in part, and forming the result of the referred method, towards one target, or several targets, which produces, by Bremsstrahlung effect, one beam, or several beams themselves entangled between each other, in whole or in part, containing a spectrum of entangled photons, in whole or in part, composed of gamma, X, ultraviolet, visible, or infra-red, according to the energy of the incident electrons, whose photons of each beam are themselves entangled between each other, in whole or in part.

8) Method according to claim 7, characterized in that at least two accelerated entangled electron beams have transit times, between the exit of the step of acceleration and the incidence on the target exploited with the Bremsstrahlung effect for each one of the aforesaid beams, which are of the same durations in order to optimize the transfer of the entanglement between the incident entangled electrons on the aforementioned targets and the produced photons gamma, ultraviolet, visible, or infra-red that are entangled, in whole or in part.

9) Device for the implementation of the method according to claim 1 characterized in that it includes:
(a) one apparatus, or several apparatuses, of generation of free electrons especially adapted to the aforementioned step of generation of the free electrons,
(b) one apparatus, or several apparatuses, of multiplication of the free electrons especially adapted to the aforementioned step of multiplication of the free electrons,
(c) one apparatus, or several apparatuses, of acceleration of the free electrons especially adapted to the aforementioned step of acceleration of the free electrons.

10) Device according to claim 9 characterized in that it includes:
(a) one apparatus of generation of the free electrons (47) especially adapted to the aforementioned step of generation of the free electrons,
(b) one apparatus of multiplication of the free electrons (48) especially adapted to the aforementioned step of multiplication of the free electrons,
(c) one apparatus of acceleration of the free electrons (49) especially adapted to the aforementioned step of acceleration of the free electrons,
the aforementioned accelerated free electrons at the exit of the aforesaid apparatus of acceleration forming the aforementioned beam (50) of accelerated entangled electrons, in whole or in part.

11) Device according to claim 9 characterized in that it includes:
(a) one apparatus of generation of the free electrons (47) especially adapted to the aforementioned step of generation of the free electrons,
(b) one apparatus of multiplication (48) of the free electrons especially adapted to the aforementioned step of multiplication of the free electrons,
(c) one apparatus (84) for the splitting of the aforesaid beam of multiplication (85) especially adapted for proceeding to the aforementioned step of acceleration of the free electrons, to produce the aforementioned divided beams of multiplication (86, 87),
(d) two apparatuses, or several apparatuses, of acceleration (88, 89) of the free electrons especially adapted to the aforementioned step of acceleration of the free electrons,
the aforementioned free accelerated electrons at exit of the aforesaid apparatuses of acceleration forming the aforementioned beams (90, 91) of accelerated entangled electrons, in whole or in part, the aforementioned accelerated electrons themselves being entangled between each other, in whole or in part.

12) Device according to claim 9 characterized in that it includes:
(a) one apparatus of generation especially adapted to the aforementioned step of generation of the free electrons, which brings forth two generated free electron beams each one by means of a photocathode (35, 36) irradiated, or illuminated, by one of the entangled beams (29, 30) of ultraviolet, visible, or infra-red, photons, named “Signal” and “Idler”, obtained by means of a nonlinear crystal (28), for example of BBO or LBO, by illumination by means of a laser (26) fitted with a polarizer (27), the aforementioned entangled beams being called by convention “incident” beams, the aforementioned incident beams and the aforementioned photocathodes being appropriate for the photoemission, the aforementioned photocathodes transmitting the possible entanglement of the aforesaid photons of the aforesaid incident beams to the aforesaid free electrons generated to form the aforementioned generated free electron beams, entangled between each other, in whole or in part,
(b) two apparatuses of multiplication (37, 38) of the free electrons especially adapted to the aforementioned step of multiplication of the free electrons,
(c) two apparatuses of acceleration (39, 40) of the free electrons especially adapted to the aforementioned step of acceleration of the free electrons,
the aforementioned free accelerated electrons at the exit of the aforesaid apparatuses of acceleration, forming the aforementioned beams (112, 113) of entangled accelerated electrons, in whole or in part, the aforementioned accelerated electrons themselves being entangled between each other, in whole or in part.

13) Device to generate two accelerated partially entangled electron beams, characterized in that it includes:
(a) one apparatus of generation especially adapted to the generation of free electrons, which brings forth two generated free electron beams each one by means of a photocathode (35, 36) irradiated, or illuminated, by one of the entangled beams (29, 30) of ultraviolet, visible, or infra-red, photons, named “Signal” and “Idler”, obtained by means of a nonlinear crystal (28), for example of BBO or LBO, by illumination by means of a laser (26) fitted with a polarizer (27), the aforementioned entangled beams being called by convention “incident” beams, the aforementioned incident beams and the aforementioned photocathodes being appropriate for the photoemission, the aforementioned photocathodes transmitting the possible entanglement of the aforesaid photons of the aforesaid incident beams to the aforesaid free electrons generated to form the aforementioned generated free electron beams, partially entangled between each other,
(b) two apparatuses of acceleration (39, 40) of the free electrons especially adapted to the of acceleration of the free electrons,
the aforementioned free accelerated electrons at the exit of the aforesaid apparatuses of acceleration, forming the aforementioned beams (112, 113) of partially entangled accelerated electrons.

14) Device according to claim 13 to generate two partially entangled beams, composed of a spectrum of photons gamma, X, ultraviolet, visible, or infra-red, whose photons of each beam are themselves partially entangled between each other, characterized in that one directs the accelerated partially entangled electrons of the aforesaid partially entangled accelerated electron beams, towards two targets, which produce, by Bremsstrahlung effect, two beams themselves partially entangled between each other, containing a spectrum of partially entangled photons, composed of gamma, X, ultraviolet, visible, or infrared, according to the energy of the incident electrons, whose photons of each beam are themselves partially entangled between each other.
